(19) United States
(12) Patent Application Publication
(10) Pub. No.: US 2012/0261199 A1
(43) Pub. Date: Oct. 18, 2012

(54) HIERARCHICAL SENSING METHOD

(75) Inventors: Chin Hua Kuo, Pingtung City (TW); R-Ming Hsu, Zhongli City (TW)

(73) Assignee: Silicon Integrated Systems Corp., Hsinchu City (TW)

(21) Appl. No.: 13/088,562

(22) Filed: Apr. 18, 2011

(51) Int. Cl. G06F 3/044

(52) U.S. Cl. 178/18.06; 178/18.03

(57) ABSTRACT

A hierarchical sensing method for a touch panel is disclosed. The touch panel has a matrix of points for detecting a touch or touches. The method includes dividing the points into a plurality of blocks; sensing first data from the respective blocks; determining which one or ones of the blocks are touched blocks according to the first data; sensing second data from each point of the touched blocks; and determining which one or ones of the points are touched points according to the second data. By using the method of the present invention, fast sensing speed and high sensing accuracy can be both achieved.

### TECHNICAL FIELD OF THE INVENTION

The present invention relates to touch sensing technique, more particularly, to a method for sensing a touch or touches on a touch sensitive device.

### BACKGROUND OF THE INVENTION

Nowadays, touch sensitive devices are widely used in various applications. Amongst, a touch screen comprising a touch panel is very popular.

Sensing speed plays an important role in performances of the touch panel. FIG. 1 is a schematic diagram showing a touch panel 10 scanned by a conventional method. The touch panel 10 comprises a matrix of points 101. Each point 101 corresponds to a pixel, and is used to sense a touch. The structure of the touch panel 10 is widely known in this field. In addition, the structure of the touch panel 10 is not the concerned issue in the present invention, and therefore the descriptions thereof are omitted herein.

As shown in this drawing, a dash-line circle 50 indicates a touch region. Shadowed points 105 are the points relative to the touch region 50. That is, the points 105 are touched points. In the conventional sensing method, the respective points 101 of the touch panel 10 are all scanned and sensed to check each of the points is touched or not so as to identify the touched points 105. However, a lot of time is wasted to scan the unnecessary points. As a result, the response speed of the touch panel 10 for a touch is not fast enough.

Therefore, there is a need for a solution to more rapidly identify positions of touches occurring on a touch panel or the like.

### SUMMARY OF THE INVENTION

An objective of the present invention is to provide a hierarchical sensing method, which is capable of improving sensing speed with a high accuracy.

In accordance with an aspect of the present invention, a hierarchical sensing method for a touch panel having a matrix of points for detecting a touch or touches comprising: dividing the points into a plurality of blocks, each block comprising a plurality of ones of the points; sensing first data from the respective blocks; determining which one or ones of the blocks are touched blocks according to the first data; sensing second data from each point of the touched blocks; and determining which one or ones of the points are touched points according to the second data.

In accordance with another aspect of the present invention, for one round, a hierarchical sensing method for a touch panel having a matrix of points for detecting a touch or touches comprises determining a block offset, which defines how blocks of a current round to be shifted with respect to blocks of a previous round; dividing the points into a plurality of blocks according to the block offset, each block comprising a plurality of ones of the points; determining which one or ones of the blocks are touched blocks; and determining which one or ones of the points in the touched blocks are touched points.

### BRIEF DESCRIPTION OF THE DRAWINGS

The present invention will be described in detail in conjunction with the appending drawings, in which:

FIG. 1 is a schematic diagram showing a touch panel scanned by a prior art method;

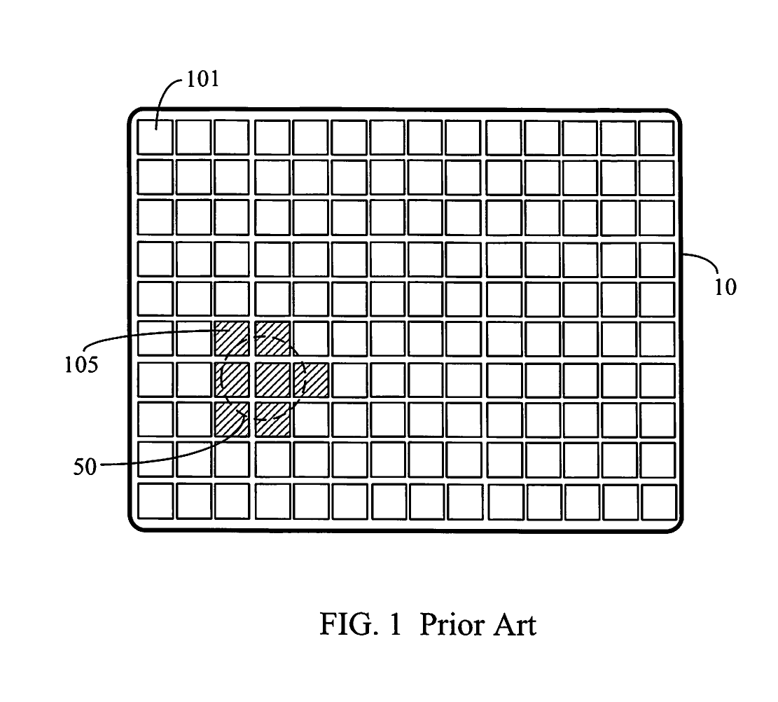

FIG. 2 is a schematic diagram showing the touch panel scanned in a first stage of a hierarchical sensing method in accordance with a first embodiment of the present invention;

FIG. 3 is a schematic diagram showing the touch panel scanned in a second stage of the hierarchical sensing method in accordance with the first embodiment of the present invention;

FIG. 4 is a schematic diagram showing the touch panel scanned by the hierarchical sensing method in accordance with a second embodiment of the present invention;

FIG. 5 is a schematic diagram showing initial counter values of the respective points of the involved blocks;

FIG. 6 is a schematic diagram showing updated counter values of the respective points of the involved blocks;

FIG. 7 is a flow chart showing the hierarchical sensing method in accordance with a third embodiment of the present invention; and

FIG. 8 is a flow chart showing the hierarchical sensing method in accordance with a fourth embodiment of the present invention.

### DETAILED DESCRIPTION OF THE INVENTION

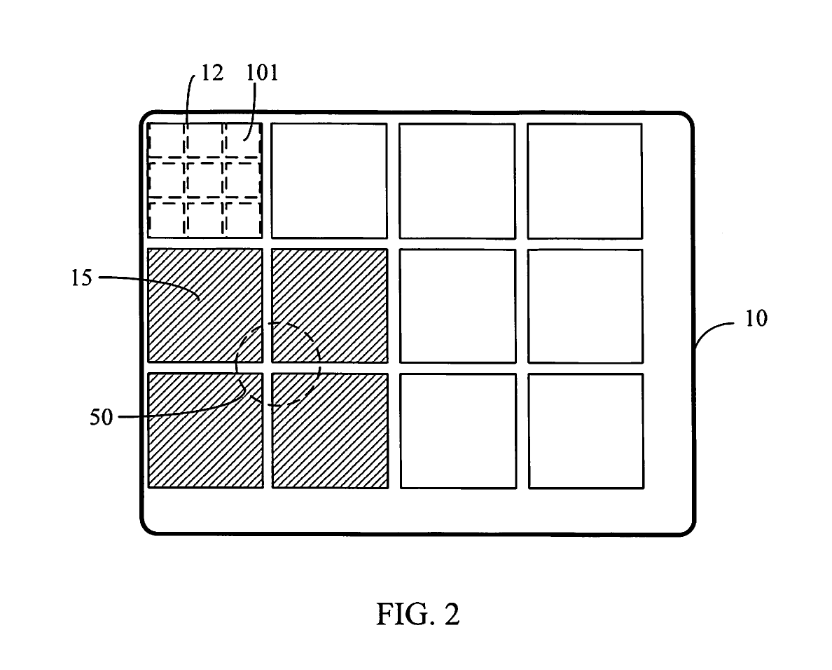

To accelerate sensing speed, the inventor of the present invention proposes a hierarchical sensing method here. In the present invention, the hierarchical sensing method comprises two stages, which will be described in detail later. FIG. 2 is a schematic diagram showing the touch panel 10 scanned in a first stage of the hierarchical sensing method in accordance with a first embodiment of the present invention. As shown, all points 101 of the touch panel 10 are grouped into multiple blocks 12. Each block 12 consists of several points 101. In the present embodiment, each block 12 includes 3×3 points 101 (i.e. nine points 101). In the first stage of the hierarchical sensing method, the touch panel 10 is scanned block by block. Sensed values of the respective blocks 12 are provided for determining which block or blocks are touched. To be distinguished from the un-touched blocks 12, the touched blocks are indicated by another reference number 15 for the sake of descriptive convenience. In practice, sensed values (e.g. capacitances) of all points 101 of one block 12 can be provided to a sensing circuit (not shown) at a time. The sensed value of a single point 101 can be referred to as a “point sensed value”. The total value of the point sensed values of all points 101 of one block 12 can be referred to as a “block sensed value”. The sensing circuit determines which block or blocks are touched by checking the block sensed values of the respective blocks 12. As shown in FIG. 2, there are four blocks related to the touched region 50. That is, these four blocks are touched. These four touched blocks 15 can be also referred to as involved blocks. The first stage can be referred to as a “block scanning stage”.

Since multiple points 101 of each block 12 are sensed at a time, the sensing time required the block scanning stage (i.e. the first stage) in the hierarchical sensing method is only 1/N, where each block comprises N points, as compared to the sensing time required by the conventional point-by-point sensing method. In the present embodiment, each block 12 comprises 9 points 101, and therefore the sensing time required by the first stage of the hierarchical method is 1/9 of the sensing time required by using the conventional point-by-point sensing method.

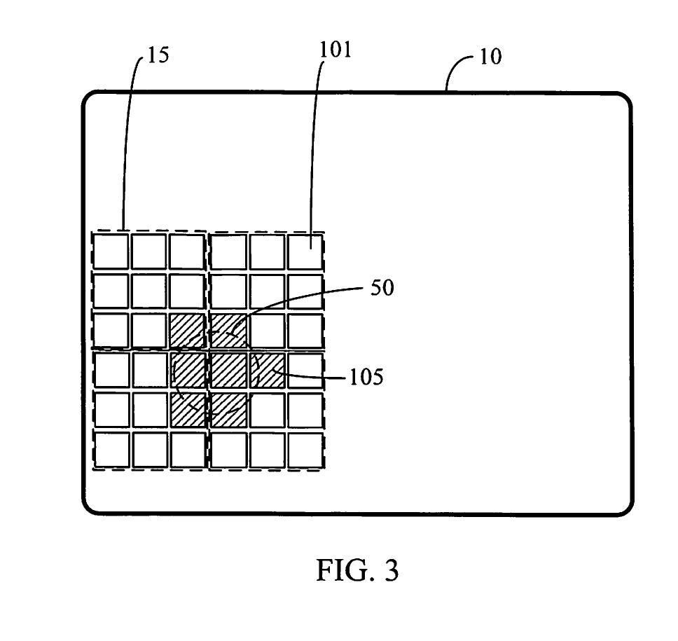

After the involved blocks 15 are determined in the first stage, all points 101 of these involved blocks 15 are scanned and checked point by point in a second stage to identify the touched points 105. FIG. 3 is a schematic diagram showing the touch panel 10 scanned in the second stage of the hierarchical sensing method in accordance with the first embodiment of the present invention. In this example, four blocks 15 (i.e. involved blocks 15) are related to the touched region 50, so there are 36 points 101 in all to be scanned and sensed. The second stage of the method can be referred to as a “point scanning stage”.

The sensing time for identifying the touched points 105 can be significantly reduced by executing the block scanning first to determine the involved blocks 15 and then executing the point scanning only to the points 101 of the involved blocks 15. However, when an object touches an edge of a specific involved block 15, that is, the touch region 50 only covers a quite small area of the involved block 15, an erroneous determination may easily occur since the total sensed value (i.e. the block sensed value) of such a block 15 is too low.

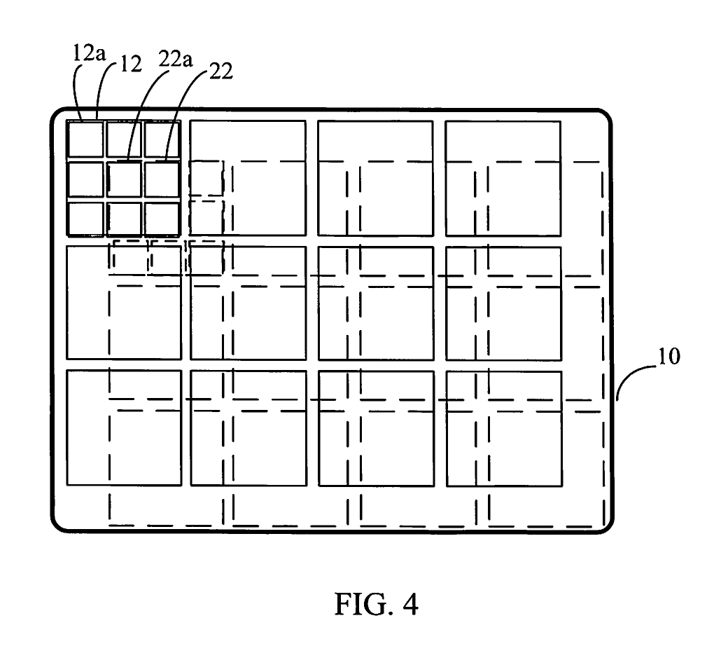

To avoid the erroneous determination mentioned above, an improvement is added in a second embodiment of the present invention. FIG. 4 is a schematic diagram showing the touch panel 10 scanned by the hierarchical sensing method in accordance with the second embodiment of the present invention. In the present embodiment, blocks 12 defined in a first round and blocks 22 defined in a second round are different. That is, there is a “block offset” between the blocks 12 and the blocks 22. The block offset is less than the size of one block. Here a “round” means that the touch panel 10 is scanned and sensed by the whole hierarchical sensing method of the present invention, that is, the block scanning stage and the point scanning stage are both executed once. It is preferred that the block offset including a vertical offset and a horizontal offset. In the example shown in FIG. 4, in the first round, the blocks to be scanned are indicated by the solid-line blocks 12, while in the second round, the blocks to be scanned are indicated by the dash-line blocks 22. The second-round blocks 22 are shifted with respect to the first-round block 12. That is, in the present embodiment, one first-round block 12a and a corresponding second-round block 22a share some points but have some different points respectively. For example, each of the block 12a and the block 22a includes nine points, in which four points are shared by the block 12a and the block 22a, and the block 12a has another five points different from the five points of the block 22a other than the shared four points as shown in this drawing. That is, the blocks 22 are shifted with respect to the blocks 12 with a block offset of one row of points and one column of points. Other block offsets are also possible. The block offset may only have the vertical or horizontal offset. It is noted that the blocks (e.g. the blocks 22) defined in a current round should partially overlap the blocks (e.g. the blocks 12) defined in the previous round. When an object touches an edge of a specific one of the first-round blocks 12, the same object is very likely to touch a central portion or near-central portion of a corresponding one of the second-round blocks 22. Therefore, the probability of erroneous determination can be reduced.

To avoid missing any point, in a third embodiment of the present invention, touched points 105 which are determined in the point scanning stage of the first round will be sensed again in the point scanning stage of the second round. Before point scanning, each point 101 of an involved block 15 can be marked. In the third embodiment of the present invention, each point 101 of an involved block 15 is initially designated with a flag. When a specific point 101 is scanned and sensed, this point 101 is de-flagged unless this point is determined as a touched point 105. That is, after a point is checked, it is maintained to be flagged if it is a touched point 105, otherwise, it is de-flagged if it is an un-touched point. The points remaining flagged after the previous round in finished are also checked in addition to the points of the involved blocks 15 in the current round.

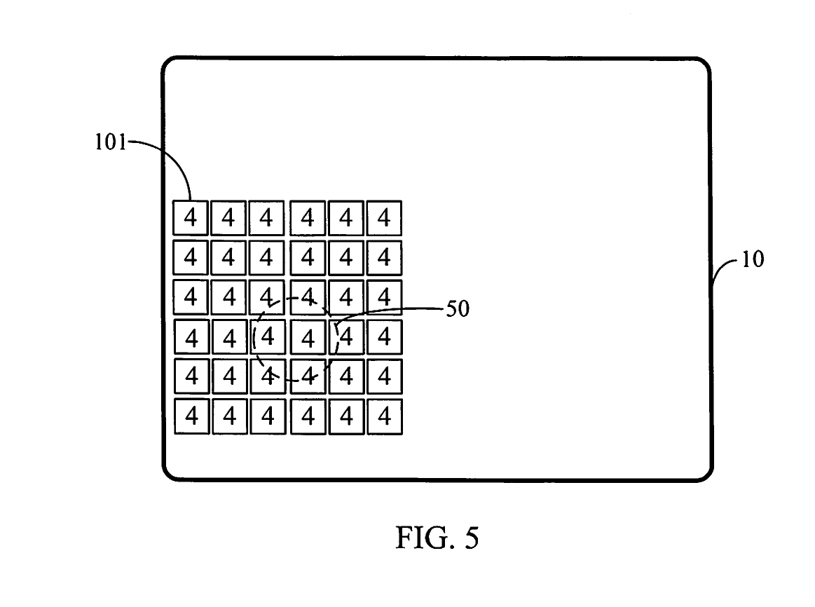

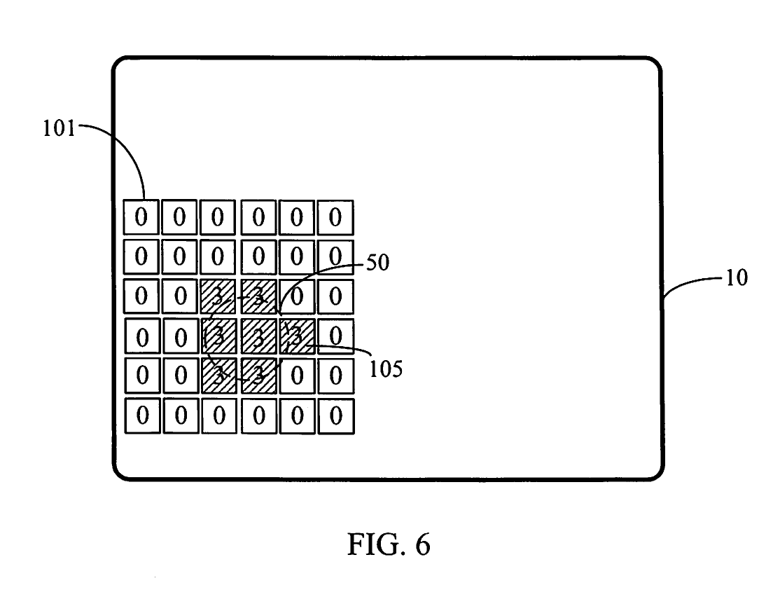

The touched points 105 identified in a round can be re-checked in more following rounds. In a fourth embodiment of the present invention, counter values are used. FIG. 5 is a schematic diagram showing that initial counter values of 4 are designated to the respective points 101 of all the involved blocks 15. It is noted that each of the points 101 of an un-touched block 12 is given with an initial counter value of zero. After the points 101 of the involved blocks 15 are scanned and sensed, the points which are touched can be identified. That is, the points relative to the touch region 50 are found. Then, the counter values of those points which are determined as un-touched points 101 are changed to zero, while the counter values of the points which are determined as touched points 105 are decremented by one. FIG. 6 is a schematic diagram showing updated counter values of the respective points of the involved blocks. As shown, the counter value of each un-touched point 101 is “0”, while the counter value of each touched point 105 becomes “3” (4−1=3). In the point scanning stage of a new round, all points having non-zero counter values (e.g. 4, 3, 2, or 1) are checked. Therefore, once a point is determined as a touched point 105, it will be scanned and sensed four times at least in this example. Any other counter value can be used as required, and any other possible scheme can be utilized to achieve repetition of checking to raise the sensing accuracy.

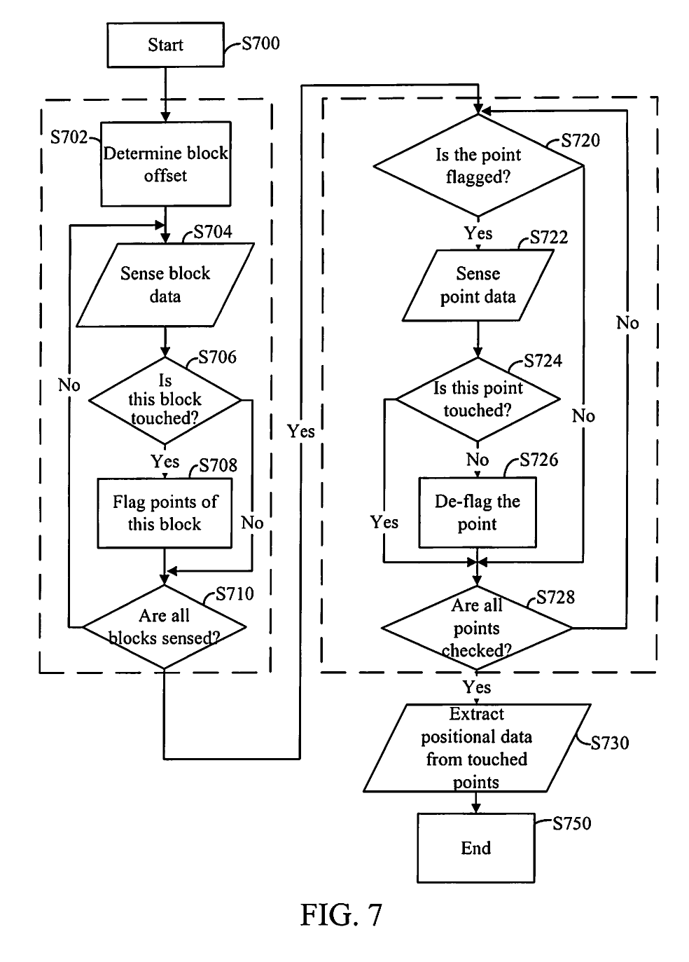

To more clarify the implementations of the present invention, the third and fourth embodiments will be further described in detail. FIG. 7 is flow chart showing the hierarchical sensing method in accordance with the third embodiment of the present invention. In step S700, the process starts. In step S702, a block offset is determined as described above. It is possible to determine a fixed block offset for all rounds. However, for the first round, the block offset is zero. In step S704, data (i.e. the block sensed values) of all blocks 12 of the touch panel 10 are sensed. In step S706, it is determined each of the blocks 12 is touched or not according to the data obtained in the step S704. If one block is determined as an involved block 15 (i.e. a block that is touched), all points 101 of this involved block 15 are flagged in step S708. In step S710, it is checked if all the blocks have been sensed. The steps S702 to S710 are subordinate to the block scanning stage.

In step S720, each point 101 of the involved block 15 is checked to determine if it is flagged. If a point 101 is flagged, then the data (i.e. point sensed value) of this point is sensed in step S722. In step S724, the flagged point is checked to determine if it is touched. If the flagged point is not touched, then this point is de-flagged in step S726. In step S728, it is determined if all the points have been checked. The steps S720 to S728 are subordinate to the point scanning stage. After all the points are checked, positional data are extracted from the touched points 105 in step S730. The process is ended in step S750.

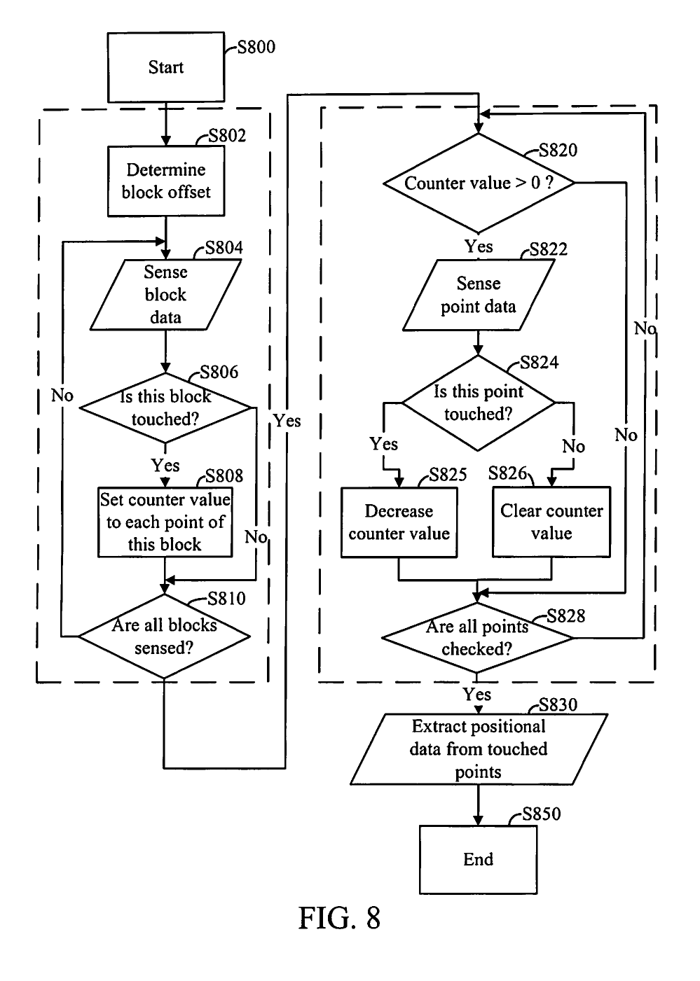

FIG. 8 is flow chart showing the hierarchical sensing method in accordance with the fourth embodiment of the present invention. In step S800, the process starts. In step S802, a block offset is determined. It is possible to determine a fixed block offset for all rounds. In step S804, data (i.e. the block sensed values) of all blocks 12 of the touch panel 10 are sensed. In step S806, it is determined each of the blocks 12 is touched or not according to the data obtained in the step S804. If one block is determined as an involved block 15 (i.e. a block that is touched), each point 101 of this block 15 is designated with an initial counter value (e.g. 4) in step S808. In step S810, it is checked if all the blocks have been sensed. The steps S802 to S810 are subordinate to the block scanning stage.

In step S820, the counter value of each point 101 of the involved block 15 is checked to see if it is non-zero. If the counter value of a point 101 is not zero, then the data (i.e. point sensed value) of this point is sensed in step S822. In step S824, the point having a non-zero counter value is checked to determine if it is touched. It is noted that any point which is outside the involved blocks 15 but has a non-zero counter value will be also sensed. If the point is touched, the counter value thereof is decreased (e.g. minus one) in step S825. If the point is not touched, then the counter value of this point is cleared (i.e. reset to zero) in step S826. In step S828, it is determined if all the points have been checked. The steps S820 to S828 are subordinate to the point scanning stage. After all the points are checked, positional data are extracted from the touched points in step S830. The process is ended in step S850.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

1. A hierarchical sensing method for a touch panel, said touch panel comprising a matrix of points for detecting a touch or touches, said method comprising:
dividing the points of the touch panel into a plurality of first blocks, each first block comprising a plurality of ones of the points;
sensing first data from the respective blocks;
determining which one or ones of the blocks are touched blocks according to the first data;
sensing second data from each point of the touched blocks; and
determining which one or ones of the points of the touched blocks are touched points according to the second data.

2. The hierarchical sensing method of claim 1, wherein the first data of one block is a total sensed value of all points of said block.

3. The hierarchical sensing method of claim 2, wherein the first data of one block is a total capacitance sensed from all points of said block.

4. The hierarchical sensing method of claim 1, wherein the second data of one point is a sensed value of said point.

5. The hierarchical sensing method of claim 4, wherein the second data of one point is a capacitance sensed from said point.

6. The hierarchical sensing method of claim 1, further comprising:
dividing the points of the touch panel into a plurality of second blocks, each second block comprising a plurality of points and partially overlapping with a corresponding one of the first blocks; and
returning to the step of sensing first data.

7. The hierarchical sensing method of claim 1, further comprising:
designating a flag to each point of the touched blocks; and
de-flagged a point that is flagged when it is determined that said point is not a touched point.

8. The hierarchical sensing method of claim 1, further comprising:
designating a counter value to each point of the touched blocks; and
clearing the counter value of a point when it is determined that said point is not a touched point, while decreasing the counter value of a point when it is determined that said point is a touched point.

9. The hierarchical sensing method of claim 8, further comprising:
checking the counter value of a point,
wherein the second data of a point which is outside the touched blocks but has a non-zero counter value is also sensed in the step of sensing second data.

10. A hierarchical sensing method for a touch panel, said touch panel comprising a matrix of points for detecting a touch or touches, when being executed for one round, said method comprising:
determining a block offset, which defines how blocks of a current round to be shifted with respect to blocks of a previous round;
dividing the points of the touch panel into a plurality of blocks according to the block offset, each block comprising a plurality of ones of the points;
determining which one or ones of the blocks are touched blocks; and
determining which one or ones of the points in the touched blocks are touched points.

11. The hierarchical sensing method of claim 10, wherein the block offset is less than a size of one block.

12. The hierarchical sensing method of claim 10, wherein the block offset comprises a vertical offset and a horizontal offset.

13. The hierarchical sensing method of claim 10, wherein the block offset is zero for the first round of execution of the method.

14. The hierarchical sensing method of claim 10, further comprising:
designating a flag to each point of the touched blocks; and
de-flagged a point that is flagged when it is determined that said point is not a touched point.

15. The hierarchical sensing method of claim 10, further comprising:
designating a counter value to each point of the touched blocks; and
clearing the counter value of a point when it is determined that said point is not a touched point, while decreasing the counter value of a point when it is determined that said point is a touched point.

16. The hierarchical sensing method of claim 15, further comprising:
checking the counter value of a point; and
determining whether a point which is outside the touched blocks but has a non-zero counter value is a touched point.

17. The hierarchical sensing method of claim 16, wherein the points outside the touched blocks but having non-zero counter values are determined to be touched points or not together with the points of the touched blocks.
